(19) United States
(12) Patent Application Publication
(10) Pub. No.: US 2016/0012133 A1
(43) Pub. Date: Jan. 14, 2016

(54) METHOD AND APPARATUS FOR SETTING INFLUENCE INDEX OF USER IN NETWORK SERVICE

(71) Applicant: RANKWAVE CO., LTD., Seocho-gu Seoul (KR)

(72) Inventors: Sung Hwa SHIM, Seoul (KR); Hyung Suk KIM, Seoul (KR); Hyeong Ju JEON, Bucheon-si Gyeonggi-do (KR); Hyoung Eun KIM, Yeoju-gun Gyeonggi-do (KR); Woong Kyung CHUNG, Seoul (KR); Eun Jung YOUK, Seoul (KR); Myeong Ho ROH, Seongnam-si Gyeonggi-do (KR)

(73) Assignee: RANKWAVE CO., LTD, Yongsan-gu, Seoul (KR)

(21) Appl. No.: 14/772,931

(22) PCT Filed: Mar. 5, 2013
(86) PCT No.: PCT/KR2013/001750

§ 371 Date: Sep. 4, 2015

(51) Int. Cl. G06F 17/30

(52) U.S. Cl. CPC G06F 17/30864; G06F 17/30336

(57) ABSTRACT

Provided is a method for setting an influence index of a first user in a network service. The method includes: identifying uploaded data and an action of a second user with respect to the uploaded data in at least one network service in which the first user is enrolled; determining an action index for the action of the second user; determining a data index of the uploaded data based on the action index; and setting the influence index of the first user based on the determined data index.

### BACKGROUND

1. Technical Field

The present invention relates to a method and apparatus for setting an influence index of a user, and more particularly, to a method and apparatus for setting an influence index of a user according to an action of the user in a network service.

2. Related Art

With the rapid growth of the Internet and the increase in the use of smartphones, more network services have been developed and used. Recently, a network service, in particular, a social network service, has been used by a lot of users. Due to the use by a lot of users, a vast amount of data is exposed to individuals. Therefore, there is great inconvenience in that users have to view data meaningless thereto.

### SUMMARY OF THE DISCLOSURE

A technical problem to be solved by the present invention is to provide a method and apparatus for determining a data index for an action index based on a response action of other user with respect to data uploaded in a network service and setting an influence index of a user based on the data index. Another technical problem to be solved by the present invention is to provide a method and apparatus for preferentially providing data uploaded by a user having a high influence index.

In order to solve the above technical problem, a method for setting an influence index of a first user in a network service includes: identifying uploaded data and an action of a second user with respect to the uploaded data in at least one network service in which the first user is enrolled; determining an action index for the action of the second user; determining a data index of the uploaded data based on the action index; and setting the influence index of the first user based on the determined data index.

In order to solve the above technical problem, an apparatus for setting data ranking of data uploaded by a first user in a network service includes: a communication unit configured to receive information about an action of a second user with respect to data from the network service; a storage unit configured to store a value preset to the action of the second user; and a control unit configured to extract the value preset to the action of the second user from the storage unit, determine an action index by adding a probability related to occurrence of the action to the preset value, and determine a data index of the data based on the action index.

According to an embodiment of the present invention, a method for setting an influence index of a first user in a network service includes: identifying uploaded data and an action of a second user with respect to the uploaded data in at least one network service in which the first user is enrolled; determining an action index for the action of the second user; determining a data index of the uploaded data based on the action index; and setting the influence index of the first user based on the determined data index.

The setting of the influence index of the first user may include: extracting a stored previous influence index of the first user; and setting the influence index of the first user based on the previous influence index of the first user and the determined data index.

The determining of the action index for the action of the second user may include determining an influence index of the second user and the action index for the action of the second user. The determining of the data index of the uploaded data based on the action index may include determining the data index of the uploaded data based on the influence index of the second user and the action index.

The determining of the influence index of the second user may include: extracting the stored previous influence index of the second user; determining the data index of the data uploaded by the second user until a predetermined time point; and determining the influence index of the second user based on the previous influence index of the second user and the data index of the data uploaded by the second user.

The determining of the action index for the action of the second user may include: extracting a value preset to the action of the second user; adding a preset weight to the preset value; and determining the action index for the action of the second user based on the preset value and the preset weight.

The extracting of the action index for the action of the second user may include: extracting a value preset to the action of the second user; and determining the action index by adding a probability related to occurrence of the action to the preset value.

The method for setting the influence index may further include preferentially displaying data uploaded by a user according to a set influence index among a plurality of users.

According to another embodiment of the present invention, an apparatus for setting an influence index of a first user in a network service includes: a communication unit configured to receive information about an action of a second user with respect to data uploaded by the first user from at least one network service in which the first user is enrolled; and a control unit configured to determine an action index for the action of the second user, determine a data index of the uploaded data based on the action index, and set the influence index of the first user based on the determined data index.

### BRIEF DESCRIPTION OF THE DRAWINGS

FIG. 1 is a flowchart of a method for setting an influence index of a user in a network service according to an embodiment of the present invention.

FIGS. 2 to 5 are histograms of Tables 2 to 5, respectively.

FIG. 6 is a flowchart of a method for setting an influence index of a user in a network service according to another embodiment of the present invention.

FIG. 7 is a diagram illustrating an example of an interface associated with an influence index according to an embodiment of the present invention.

FIG. 8 is a block diagram of an apparatus for setting an influence index of a user in a network service according to an embodiment of the present invention.

### DETAILED DESCRIPTION OF EXEMPLARY EMBODIMENTS

In the present invention, an influence index means an influence calculated according to an action of a certain user in a network service or a response action of other user with respect to the action of the certain user, that is, a response degree of other user. An action of a socially famous person or a response action of a famous person with respect to an action of other user has a greater ripple effect or a greater influence on a network service than an action of an ordinary person. An apparatus for setting an influence index calculates an influence index of a user by analyzing an action of a certain user in a network service, that is, an action attitude of other user with respect to uploaded data. A detailed description thereof will be described below.

Preferred embodiments of the present invention will be described in detail with reference to the accompanying drawings.

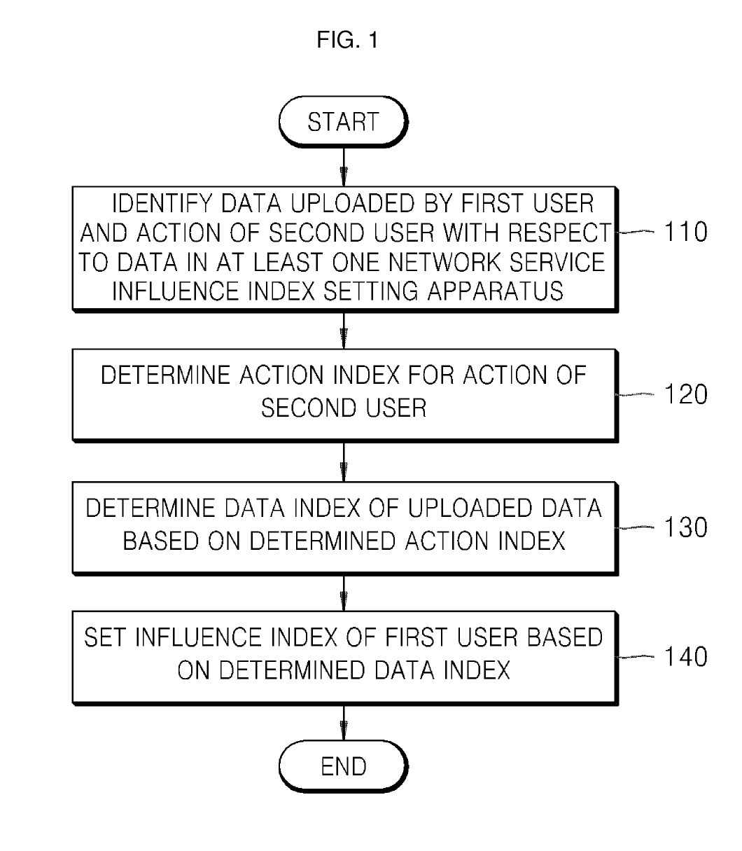

FIG. 1 is a flowchart of a method for setting an influence index of a user in a network service according to an embodiment of the present invention.

Referring to FIG. 1, in step 110, an apparatus that performs the method for setting the influence index of the user in the network service (hereinafter, referred to as an “influence index setting apparatus”) identifies data uploaded by a first user and an action of a second user with respect to the uploaded data in at least one network service which the first user has joined or has been enrolled in. The user means a user who has been enrolled in or joined at least one network service and uses the network service. For example, the network service may be a social network service. It is preferable that the influence index setting apparatus is provided separately from the network service which the user has joined. The data means all objects that are exchanged between the users in the network service. For example, the data may be information, news, images, videos, URL, position information, and the like. The above-described data is merely exemplary and is not limited thereto. The action of the user means an action of a user that is conducted in the network service. Examples of the action of the user include an action of posting a message in a network service such as Facebook, an action of posting a comment or clicking “LIKE”, an action of uploading data such as images or videos, an action of sharing the uploaded data, an action of tweeting in a network service such as Twitter, and an action of retweeting a tweet of other person. The above-described actions of the user are merely exemplary and are not limited thereto. The action of the first user means the first user's uploading data in the network service. In the examples of the actions of the user, posting a message, data uploading, and tweeting may be regarded as the action of the first user. The action of the second user means a response action with respect to the action of the first user. That is, the action of the second user means a response action with respect to the data uploaded by the first user. In the examples of the actions of the user, posting a comment, clicking “LIKE”, sharing the uploaded data, and retweeting may be regarded as the action of the second user.

The influence index setting apparatus can grasp the action of the user, that is, behavior of the user, in at least one network service and the action of other user with respect to the action of the user by using an access token in the at least one network service which the user has joined. The influence index setting apparatus can use the access token to access resources of the network service which the user has joined. The access token is used to request a network service API instead of the corresponding user. It is possible to acquire a variety of information about the user in a data index setting network service. The Facebook will be taken as an example of the network service. In the case of the Facebook, OAuth-based Open API is provided. The key point of the OAuth authentication is to allow a user ID and a password to be input in a page of the Facebook and issue an access token when the ID and the password are matched. In addition, the issued access token may be collected whenever the user wants. If the OAuth method is not used, in the case of creating a linked page logging in to the Facebook, a user's Facebook ID and password are received in a network service to be linked and it is checked whether the ID and the password are matched by using a server-to-server interface provided in the Facebook. However, such a method has a security problem because the user's password can be known in the network service to be linked. Accordingly, the confidence of the service to be linked has to be based and a method of collecting issued authentication information after authentication is unclear. In order to solve these problems, the user's ID and password are input in a service page provided in the Facebook, and an encrypted token is issued so as to make Open API available. In addition to the information indicating that the user has been authenticated, information about the accessible API is included in the access token. In some cases, it is possible to make the corresponding token unavailable by setting the token to be invalid. If the user directly inputs the ID and the password in the page provided in the Facebook and has the access token issued through authentication, the access to the following information is enabled. Examples of the information accessible in the Facebook include “accounts” information that is page information held by the accounts, “activities” information that is profile information about activities, “adaccounts” information that is advertisement management account information, “albums” information that is information about albums, “apprequests” information that is application request information, “books” information that is profile information about books, “checkins” information that is local-based check-in information, “cover” information that is photo information used in a cover, “events” information that is information about events, “family” information that is information about families, “feed” information that is information about activities I have conducted to friends and information about messages I have posted, “friendlists” information that is list information, “friendrequests” information that is friend request information, “friends” information that is information about all friends, “games” information that is profile information about games, “groups” information that is information about groups within the Facebook, “home” information that is information about postings generated in my network, “inbox” information that is information about a folder for holding incoming messages, “interests” information that is information about a matter of interest, “likes” information that is information about favorite things, pages, applications, profiles, “links” information that is information about shared links, “movies” information that is profile information about movies, “music” information that is profile information about music, “mutualfriends” information that is information about mutual friends, “notes” information that is note information, “notifications” information that is information about notifications, “outbox” information that is information about a folder for holding outgoing messages, “payments” information that is information about payments, “permissions” information that is information to which access is permitted by a current access token, “photos” information that is information about tagged photos, “picture” information that is profile photo information, “posts” information that is information about messages I have posted, “scores” information that is information about scores recorded in game applications or the like, “statuses” information that is information about messages I have posted on a wall, “tagged” information that is tagged information, “television” information that is information about TV-related profile, “updates” information that is information about updates, and “video” information that is video-related profile information. The influence index setting apparatus can identify the action of the first user and the action of the second user based on all or part of the information accessible by using the access token. The influence index setting apparatus can receive information through periodic or non-periodic access to the network service, identify the actions of the users based on the received information, and acquire an influence index and a data index to be described below.

In step 120, the influence index setting apparatus determines an action index for the action of the second user. The action index means a value that is set to a response action with respect to an action of a certain user. The action index is calculated using Mathematical Formula 1 below.

SA(x)=f_{SA}(f_{RE}(r),f_{LK}(l),f_{RT}(i),f_{SH}(s)) Mathematical Formula 1

In Mathematical Formula 1, SA( ) represents an action index, and x represents a second user who has conducted an action. Also, r represents the number of times of posting a comment, l represents “LIKE” or “DISLIKE”, i represents an initial action start time of the second user, and s represents share or “no share”. The response action with respect to an action of a certain user, which is expressed in Mathematical Formula 1, is merely exemplary and is not limited thereto. This can be applied to various response actions according to service aspects of the network service.

According to the embodiment of the present invention, the action index can be obtained based on values preset according to the aspects of the response actions. In this regard, the action index is calculated using Mathematical Formula 2 below.

$$\begin{matrix}SA ( x ) = {f}_{SA} ( {f}_{RE} ( r ) , {f}_{LK} ( l ) , {f}_{RT} ( i ) , {f}_{SH} ( s ) ) \\ = {f}_{RE} ( r ) + {f}_{LK} ( l ) + {f}_{RT} ( i ) + {f}_{SH} ( s ) \\ = r + l + i + s\end{matrix} \qquad Mathematical Formula 2$$

In Mathematical Formula 2, the action index is the sum of the values preset according to the aspects of the response actions. The use of the sum in the action index is merely exemplary and the calculation formula may be different according to circumstances. Referring to Mathematical Formula 2, for example, the preset values may be set as follows: r=n when there are n comments, r=0 when there are no comments, l=1 when there is “LIKE”, l=0 when there is no “LIKE”, i=1 when there is the action of the second user within a predetermined time, i=0 when there is no action of the second user within the predetermined time, s=1 when there is the share, and s=0 when there is no share. The preset values are merely exemplary and can be differently set according to an action index provider. In this case, for example, the action index becomes 2(1+1) when there are only “LIKE” and “share” as the actions of the second users with respect to the data uploaded by the first user.

According to another embodiment of the present invention, the action index can be calculated by adding weights to the values preset according to the aspects of the response actions. In this regard, the action index is calculated using Mathematical Formula 3 below.

$$\begin{matrix}SA ( x ) = {f}_{SA} ( {f}_{RE} ( r ) , {f}_{LK} ( l ) , {f}_{RT} ( i ) , {f}_{SH} ( s ) ) \\ = {f}_{RE} ( r ) + {f}_{LK} ( l ) + {f}_{RT} ( i ) + {f}_{SH} ( s ) \\ = a \times r + b \times l + c \times i + d \times s\end{matrix} \qquad Mathematical Formula 3$$

Mathematical Formula 3 is defined by adding the weights to the preset values in Mathematical Formula 2. Referring to Mathematical Formula 3, a, b, c, and d are weight coefficients. The weights may be differently determined according to the setting of the action index provider. For example, the preset values may be set as follows: r=n when there are n comments, r=0 when there are no comments, l=1 when there is “LIKE”, l=0 when there is no “LIKE”, i=1 when there is the action of the second user within a predetermined time, i=0 when there is no action of the second user within the predetermined time, s=1 when there is the share, s=0 when there is no share, and the weights are set to a=2, b=0.5, c=1, and d=2. In this case, the action index becomes 2.5(0.5×1+2×1) when there are only “LIKE” and “share” as the actions of the second users with respect to the data uploaded by the first user.

According to another embodiment of the present invention, the action index can be calculated by adding a probability related to the occurrence of the action to the values preset according to the aspects of the response actions. In this regard, the action index is calculated using Mathematical Formula 4 below.

$$\begin{matrix}SA ( x ) = {f}_{SA} ( {f}_{RE} ( r ) , {f}_{LK} ( l ) , {f}_{RT} ( i ) , {f}_{SH} ( s ) ) \\ = {f}_{RE} ( r ) + {f}_{LK} ( l ) + {f}_{RT} ( i ) + {f}_{SH} ( s ) \\ = ( 1 - {k}_{1} \times {E}_{RE} ( r ) ) + ( 1 - {k}_{2} \times {E}_{LK} ( l ) ) + \\ ( 1 - {k}_{3} \times {E}_{RT} ( i ) ) + ( 1 - {k}_{4} \times {E}_{SH} ( s ) )\end{matrix} \qquad Mathematical Formula 4$$

In Mathematical Formula 4, k₁ to k₄ are weights for probability items. The weights for the probability items can be changed according to the setting of the setter. E_{RE}(r) represents a probability that more than a predetermined number of comments will be posted, E_{LK}(l) represents a probability that “LIKE” will be selected, E_{RT}(i) represents a probability that the action of the second user will be conducted within a predetermined time, and E_{SH}(s) represents a probability that the share will be selected. The above-described formula is merely exemplary and the present invention is not limited thereto. In addition, in Mathematical Formula 4, a case where there is no action of the second user is not considered. For example, in a case where the second user selects only “LIKE” without comment and share, the function related to the comment and the share is not considered and S(x)=f_{LK}(l)=(1−k₂×E_{LK}(l)). Similar to Mathematical Formula 3, weights can be further added to Mathematical Formula 4 according to the aspects of the actions. According to another aspect of the present invention, in a case where there is no access token for a user who intends to calculate the action index, information cannot be acquired from the network service and the action index cannot be calculated. In this case, the influence index setting apparatus calculates an average value of the probabilities of users having the access token as the action index.

In the embodiment of the present invention, after the information about the action is extracted, the probability is calculated using a normal distribution. The normal distribution is merely an example of calculating the probability, and there is no limitation to a probability calculating method. When the action of the user is conducted predetermined times or more, a probability distribution of the corresponding action to be conducted forms a normal distribution. A probability density function may be assumed as a Gaussian function. Thereafter, in the case of calculating an average value and a standard deviation or a variance value, it is possible to estimate a probability of a certain action. Mathematical Formula 5 below is a Gaussian function that is a probability density function.

$${f}_{x} ( x ) = \frac{1}{\sqrt{2 π {σ}^{2}}} {e}^{- \frac{( x - μ ) 2}{2 {σ}^{2}}} ( - ∞ < x < ∞ ) \qquad Mathematical Formula 5$$

In Mathematical Formula 5, fₓ( ) represents a Gaussian function, x represents a random variable, μ represents an average, and σ² represents a variance.

According to another embodiment of the present invention, the action index can be calculated using the probability related to the occurrence of the action with respect to the values preset according to the aspects of the response actions and the highest probability among the probabilities. In this regard, the action index is calculated using Mathematical Formula 6 below.

$$\begin{matrix}SA ( x ) = {f}_{SA} ( {f}_{RE} ( r ) , {f}_{LK} ( l ) , {f}_{RT} ( i ) , {f}_{SH} ( s ) ) \\ = {f}_{RE} ( r ) + {f}_{LK} ( l ) + {f}_{RT} ( i ) + {f}_{SH} ( s ) \\ {f}_{RE} ( r ) = \{ \begin{matrix}{k}_{1} \times {E}_{RE} ( r ) & ( r \leq {r}_{m , max} ) \\ {k}_{1} \times ( {M}_{RE} + {M}_{RE} - {E}_{RE} ( r ) ) & ( otherwise )\end{matrix} \\ {f}_{LK} ( l ) = 1 - {k}_{2} \times {E}_{LK} ( l ) \\ {f}_{RT} ( i ) = \{ \begin{matrix}{k}_{3} \times ( {M}_{RT} + {M}_{RT} - {E}_{RT} ( i ) ) & ( i \leq {i}_{m , max} ) \\ {k}_{3} \times {E}_{RT} ( i ) & ( otherwise )\end{matrix} \\ {f}_{SH} ( s ) = 1 - {k}_{4} \times {E}_{SH} ( s )\end{matrix} \qquad Mathematical Formula 6$$

Referring to Mathematical Formula 6, if the number of times of the second user's posting a comment in f_{RE}(r) is less than r_{m,max} that is the highest probability of posting the comment, k₁×E_{RE}(r), and if not, k₁×(M_{RE}(r)+M_{RE}(r)−E_{RE}(r)). M_{RE}(r) represents the highest probability of posting the comment. In addition, if the comment is posted more promptly than i_{m,max} that is the highest probability among probabilities of the time at which the second user posts the comment, k₃×(M_{RT}+M_{RT}−E_{RT}(i)), and if not, k₃×E_{RT}(i). M_{RT} represents the highest probability among probabilities of times at which the comment is posted. f_{LK}(l) and f_{SH}(s) are the same as Mathematical Formula 4.

An example of the probability necessary for determining the action index will be described below. Table 1 shows the number of comment posting actions that are response actions of the second users A, B, C, and D with respect to the data uploaded by the first user.

TABLE 1

| Number of | Number of | Number of | Number of |
|---|---|---|---|
| Comments Posted | Comments Posted | Comments Posted | Comments |
| by A | by B | by C | Posted by D |
| 2 | 2 | 2 | 1 |
| 0 | 0 | 2 | 0 |
| 1 | 1 | 3 | 0 |
| 1 | 1 | 0 | 0 |
| 0 | 0 | 2 | 1 |
| 0 | 0 | 0 | 1 |
| 2 | 0 | 3 | 0 |
| 0 | 1 | 1 | 1 |
| 0 | 1 | 0 | 1 |
| 1 | 0 | 2 | 0 |
| 0 | 0 | 2 | 0 |
| 0 | 1 | 3 | 1 |
| 0 | 0 | 2 | 1 |
| 1 | 0 | 2 | 1 |
| 0 | 0 | 2 | 1 |
| 0 | 1 | 2 | 1 |
| 0 | 0 | 2 | 0 |
| 0 | 1 | 2 | 0 |
| 0 | 0 | 2 | 0 |
| 0 | 0 | 3 | 0 |
| 1 | 0 | 1 | 2 |
| 1 | 1 | 2 | 0 |
| 0 | 1 | 2 | 1 |
| 0 | 0 | 2 | 0 |
| 0 | 0 | 2 | 0 |
| 0 | 1 | 2 | 1 |
| 0 | 1 | 2 | 0 |
| 0 | 0 | 2 | 0 |
| 1 | 1 | 2 | 0 |
| 1 | 0 | 2 | 0 |
| 0 | 0 | 0 | 1 |
| 0 | 1 | 0 | 0 |
| 0 | 0 | 0 | 0 |
| 0 | 0 | 0 | 0 |
| 0 | 0 | 2 | 0 |
| 1 | 1 | 0 | 0 |
| 1 | 0 | 2 | 0 |
| 0 | 0 | 2 | 1 |
| 0 | 1 | 2 | 1 |
| 0 | 0 | 2 | 0 |
| 1 | 0 | 3 | 0 |
| 1 | 0 | 2 | 0 |
| 0 | 0 | 2 | 0 |
| 1 | 0 | 2 | 1 |
| 0 | 0 | 2 | 0 |
| 0 | 1 | 2 | 0 |
| 0 | 0 | 2 | 1 |
| 0 | 0 | 2 | 0 |
| 2 | 1 | 1 | 0 |
| 0 | 0 | 2 | 0 |
| 0 | 1 | 2 | 0 |
| 0 | 0 | 2 | 0 |
| 0 | 0 | 2 | 1 |
| 0 | 0 | 3 | 0 |
| 0 | 1 | 3 | 0 |
| 0 | 1 | 2 | 0 |
| 1 | 0 | 2 | 0 |
| 0 | 0 | 2 | 0 |
| 1 | 0 | 2 | 0 |
| 0 | 0 | 2 | 0 |

Tables 2 to 5 below show comment probabilities of the second users A, B, C, and D based on Table 1. Referring to Tables 2 to 5, the number of times of the actions of the users A, B, C, and D, the frequency of the actions of the users A, B, C, and D, and the probability density according to the number of times of the actions of the users A, B, C, and D are shown.

TABLE 2

| Number of Times | Frequency | Probability Density |
|---|---|---|
| 0 | 42 | 0.57820441 |
| 1 | 15 | 0.365736157 |
| 2 | 3 | 0.010918535 |
| 3 | 0 | 1.53841E−05 |
| 4 | 0 | 1.02303E−09 |
| 5 | 0 | 3.2108E−15 |
| Others | 0 | |

Table 2 shows the probability density with respect to the action of the user A. Referring to Table 1, the average number of times of the actions of the user A was 0.35, the standard deviation was 0.5722762, and the probability density was obtained as shown in Table 2. Referring to Table 2, the probability that the user A will post two comments on the action of the first user is 1.09%.

TABLE 3

| Number of Times | Frequency | Probability Density |
|---|---|---|
| 0 | 39 | 0.601029655 |
| 1 | 20 | 0.363781068 |
| 2 | 1 | 0.0050976 |
| 3 | 0 | 1.65376E−06 |
| 4 | 0 | 1.24211E−11 |
| 5 | 0 | 2.15989E−18 |
| Others | 0 | |

Table 3 shows the probability density with respect to the action of the user B. Referring to Table 1, the average number of times of the actions of the user B was 0.3666667, the standard deviation was 0.5156208, and the probability density was obtained as shown in Table 3. Referring to Table 3, the probability that the user B will post one comment on the action of the first user is 36.37%.

TABLE 4

| Number of Times | Frequency | Probability Density |
|---|---|---|
| 0 | 8 | 0.042183494 |
| 1 | 3 | 0.302392542 |
| 2 | 42 | 0.476406479 |
| 3 | 7 | 0.16495379 |
| 4 | 0 | 0.012552349 |
| 5 | 0 | 0.000209926 |
| Others | 0 | |

Table 4 shows the probability density with respect to the action of the user C. Referring to Table 1, the average number of times of the actions of the user C was 1.8, the standard deviation was 0.8124038, and the probability density was obtained as shown in Table 4. Referring to Table 4, the probability that the user C will post three comments on the action of the first user is 16.49%.

TABLE 5

| Number of Times | Frequency | Probability Density |
|---|---|---|
| 0 | 41 | 0.634973438 |
| 1 | 18 | 0.630765365 |
| 2 | 1 | 0.0034442479 |
| 3 | 0 | 7.15829E−07 |
| 4 | 0 | 2.97395E−12 |
| 5 | 0 | 2.46857E−19 |
| Others | 0 | |

Table 5 shows the probability density with respect to the action of the user D. Referring to Table 1, the average number of times of the actions of the user D was 0.3333333, the standard deviation was 0.505525, and the probability density was obtained as shown in Table 5. Referring to Table 5, the probability that the user D will post one comment on the action of the first user is 33.07%.

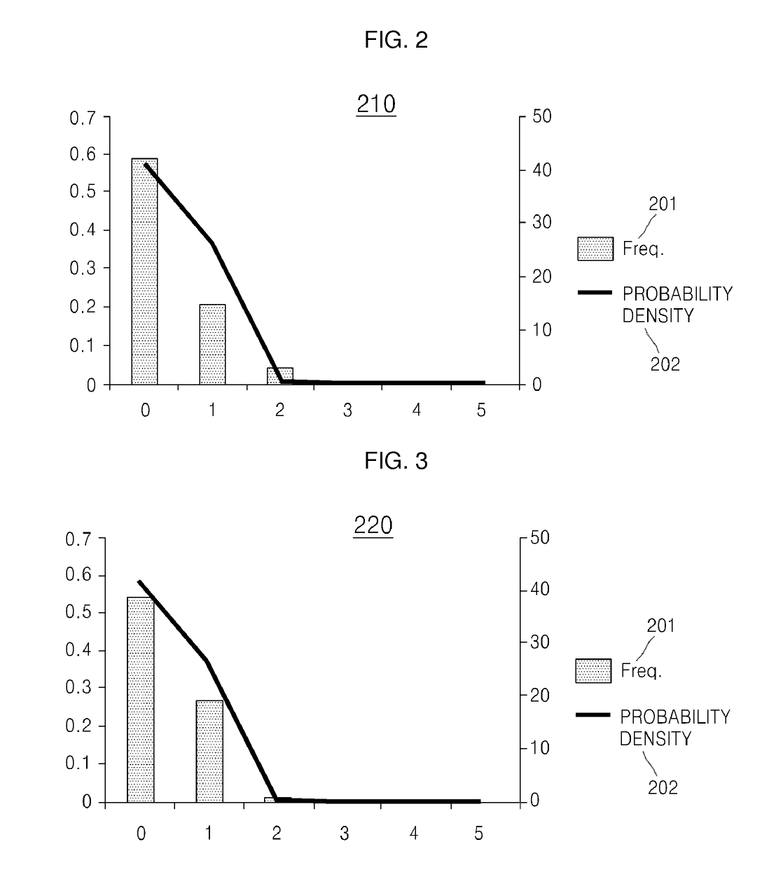

FIGS. 2 to 5 are histograms of Tables 2 to 5, respectively.

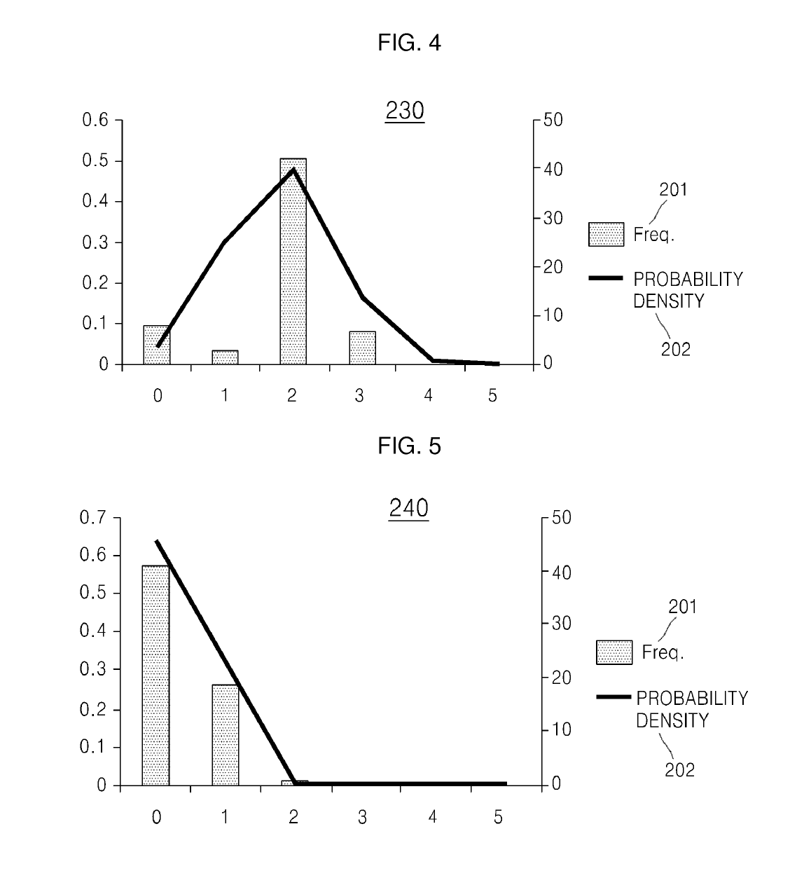

FIG. 2 is a histogram 200 of the probability density with respect to the action of the second user A, FIG. 3 is a histogram 300 of the probability density with respect to the action of the second user B, FIG. 4 is a histogram 400 of the probability density with respect to the action of the second user C, and FIG. 5 is a histogram 500 of the probability density with respect to the action of the second user D. Referring to FIGS. 2 to 5, Freq 201 to Freq 501 represent the frequencies of comments, and the probability densities 202 to 502 represent probability densities according to the number of times and the frequencies. A left vertical axis represents the probability density and a right vertical axis represents the frequency.

Hereinafter, an example of calculating the action index according to Mathematical Formulas 4 and 6 will be described.

Table 6 relates to a response action (that is, a comment) of other users with respect to data uploaded by the user during a predetermined period. In Table 6, it is assumed that all of the users A, B, C, and D upload twenty pieces of data.

TABLE 6

| Data Uploaded by A | | | | | | Data Uploaded by B | | | | | | Data Uploaded by C | | | Data Uploaded by D | | | | |
|---|---|---|---|---|---|---|---|---|---|---|---|---|---|---|---|---|---|---|---|
| 1 | B | B | D | B | C | 1 | A | D | D | A | C | 1 | A | | 1 | A | C | C | C |
| 2 | C | C | | | | 2 | C | C | | | | 2 | B | A | 2 | A | C | C | |
| 3 | B | C | C | C | | 3 | D | A | C | C | | 3 | B | | 3 | C | C | | |
| 4 | B | | | | | 4 | C | A | C | | | 4 | D | | 4 | C | A | C | |
| 5 | C | D | C | | | 5 | C | C | | | | 5 | | | 5 | C | C | | |
| 6 | D | | | | | 6 | D | C | C | | | 6 | B | | 6 | B | C | C | |
| 7 | C | C | C | | | 7 | A | A | C | C | | 7 | D | B | 7 | C | C | | |
| 8 | B | C | D | | | 8 | C | C | | | | 8 | | | 8 | C | C | | |
| 9 | B | D | | | | 9 | C | C | | | | 9 | A | B | 9 | B | C | A | A |
| 10 | C | C | | | | 10 | A | C | C | | | 10 | A | | 10 | C | C | | |
| 11 | C | C | | | | 11 | D | | | | | 11 | | | 11 | B | C | C | |
| 12 | B | D | C | C | C | 12 | | | | | | 12 | B | | 12 | C | C | | |
| 13 | D | C | C | | | 13 | | | | | | 13 | D | | 13 | C | C | | |
| 14 | D | C | C | | | 14 | A | | | | | 14 | | | 14 | C | C | C | |
| 15 | D | C | C | | | 15 | C | C | | | | 15 | | | 15 | B | C | C | C |
| 16 | B | D | C | C | | 16 | | | | | | 16 | A | B | 16 | B | C | C | |
| 17 | C | C | | | | 17 | C | C | | | | 17 | A | | 17 | A | C | C | |
| 18 | B | C | C | | | 18 | D | C | C | | | 18 | | | 18 | C | C | | |
| 19 | C | C | | | | 19 | D | C | C | | | 19 | B | | 19 | C | C | A | C |
| 20 | C | C | C | | | 20 | C | C | | | | 20 | | | 20 | C | C | | |

In Table 6, the numerals represent data uploaded by the user and represent other users who have posted comments on the uploaded data. The second users who have posted comments on data 1 uploaded by the user B are A, C, and D. The user A has posted the comment twice, the user C has posted the comment once, and the user D has posted the comment twice. In the following example, only the case of posting the comment is considered and the other actions are not considered. In addition, in Mathematical Formulas 4 and 6, K₁ is assumed as 1. In the following, the subscript “1” in E_{RE1}( ) and SA₁ means the relation to the data 1. Referring to Table 2, the probability density E_{RE1}(A,2) that the user A will post the comment on one piece of data twice is 0.010918535. Referring to Table 4, the probability density E_{RE1}(C,2) that the user C will post the comment on one piece of data once is 0.302392542, and the probability density E_{RE1}(D,2) that the user D will post the comment on one piece of data twice is 0.003442479.

According to Mathematical Formula 4, the active index of the case where the user A posts two comments is 0.989081465 which is obtained from SA₁(A,2)=(1−K₁×E_{RE1}(A,2)). The active index of the case where the user C posts one comment is 0.697607458 which is obtained from SA₁(C,1)=(1−K₁×E_{RE1}(C,1)). The active index of the case where the user D posts two comments is 0.996557521 which is obtained from SA₁(D,2)=(1−K₁×E_{RE1}(D,2)).

According to Mathematical Formula 6, the user A has posted the comments twice, which is greater than 0 times that are the number of times of the highest one of the probabilities that the user A will post the comment. The user D has posted the comments twice, which is greater than 0 times that are the number of times of the highest one of the probabilities that the user D will post the comment. However, the user C has posted the comment once, which is less than two times that are the number of times of the highest one of the probabilities that the user C will post the comment. Therefore, the action index of the case where the user A posts two comments is obtained from SA₁(A,2)=K₁×((M_{RE}(A)+M_{RE}(A)−E_{RE1}(A,2)). Referring to Table 2, M_{RE}(A)=0.57820441 and E_{RE1}(A,2)=0.010918535. Therefore, SA₁(A,2)=K₁×((M_{RE}(A)+M_{RE}(A)−E_{RE1}(A,2))=(0.57820441+0.57820441−0.010918535)=1.145490285. The action index of the case where the user C posts one comment is obtained from SA₁(C,1)=K₁×E_{RE1}(C,1). Referring to Table 4, E_{RE1}(C,1)=0.302392542. Therefore, SA₁(C,1)=K₁×E_{RE1}(C,1)=0.302392542. The action index of the case where the user D posts two comments is obtained from SA₁(D,2)=K₁×((M_{RE}(D)+M_{RE}(D)−E_{RE1}(D,2)). Referring to Table 5, M_{RE}(D)=0.634973438 and E_{RE1}(D,2)=0.003442479. Therefore, SA₁(D,2)=K₁×((M_{RE}(D)+M_{RE}(D)−E_{RE1}(D,2))=(0.634973438+0.634973438−0.003442479)=1.266804397.

In step 130, the influence index setting apparatus determines the data index of the uploaded data based on the action index. The influence index setting apparatus calculates the data index (value) by substituting the action index into a predetermined formula. Mathematical Formula 7 below is an example of a formula for calculating the data index.

$$DV ( N ) = {\sum }_{x = a}^{…} {f}_{DV} ( SA ( x ) ) \qquad Mathematical Formula 7$$

Referring to Mathematical Formula 7, DV( ) in DV(N) represents the data index, and N represents the data that the first user has created. x represents a set of users who have conducted response actions with respect to N data. It can be seen from Mathematical Formula 7 that the data index is calculated as the sum of the action indexes of the response actions of the second users with respect to the action of the first user.

In Table 6, an example in which the data index of the data 1 uploaded by the user B is calculated using Mathematical Formula 7 will be described. The subscript “1” in DV₁, B₁, E_{RE1}( ), and SA₁ means the relation to the data 1. According to Mathematical Formula 7, DV₁(B₁)=f_{DV}(SA₁(A,2))+f_{DV}(SA₁(C,1))+f_{DV}(SA₁(D,2)). If Mathematical Formula 4 is substituted, since f_{DV}(SA₁(A,2))=(1−K₁×E_{RE1}(A, 2))=0.989081465, f_{DV}(SA₁(C,1))=(1−K₁×E_{RE1}(C,1))=0.697607458, and f_{DV}(SA₁(D,2))=(2−K₁×E_{RE1}(D,2))=0.996557521, DV₁(B₁)=0.989081465+0.697607458+0.996557521=2.683246444. If Mathematical Formula 6 is substituted, since f_{DV}(SA₁(A,2))=K₁×((M_{RE}(A)+M_{RE}(A)−E_{RE1}(A,2))=1.145490285, f_{DV}(SA₁(C,1))=K₁×E_{RE1}(C,1)=0.302392542, and f_{DV}(SA₁(D,2))=K₁×((M_{RE}(D)+M_{RE}(D)−E_{RE1}(D,2))=1.266804397, DV₁(B₁)=1.145490285+0.302392542+1.266804397=2.714387224.

In step 140, the influence index setting apparatus sets the influence index of the first user based on the determined data index.

The influence index setting apparatus calculates the influence index based on the data index of the data that the user has created during a predetermined period. The influence index is calculated using Mathematical Formula 8 below.

$${SV}_{t} ( A ) = {\sum }_{n = 1}^{…} {f}_{sv} ( {DV}_{t} ( n ) ) \qquad Mathematical Formula 8$$

SVₜ( ) in SVₜ(A) represents an influence index of a period t, A represents a user subjected to calculation of the influence index, DVₜ( ) in DVₜ(n) represents a data index for the user A during the period t, and n represents a set of data that the user A has created.

For example, the influence index of the user A during the period 2 is SV₂(A)=DV₂(A1)+DV₂(A2)+ . . . +DV₂(AN). A1 to AN mean the number of data that the user A has uploaded during the period 2. Each of the DV₂(A1) to DV₂(AN) can be calculated using Mathematical Formula 7.

In addition, according to another embodiment of the present invention, the influence index setting apparatus may calculate the influence index by adding the influence index, which is calculated at a time point or period immediately before the time when the current influence index is calculated, to the data index of the data, which has been created by the user during a predetermined period. The influence index is calculated using Mathematical Formula 9 below.

$${SV}_{t} ( A ) = {SV}_{t - 1} ( A ) + {\sum }_{n = 1}^{…} {f}_{sv} ( {DV}_{t} ( n ) ) \qquad Mathematical Formula 9$$

Mathematical Formula 9 differs from Mathematical Formula 8 in that the influence index can be calculated by further using the influence index at t−1 that is a time or a period before t. The influence index may be calculated by summing all of the data indexes for all data uploaded by the user during a predetermined period and adding the sum to the influence index of the previous period. For example, when the specific time point is the period 2, the influence index of the user A is SV₂(A)=SV₁(A)+DV₂(A1)+DV₂(A2)+ . . . +DV₂(AN). A1 to AN mean the number of data that the user A has uploaded during the period 2. A value of SV₀(A), which is the original influence index, may be set by an operator of the influence index setting apparatus.

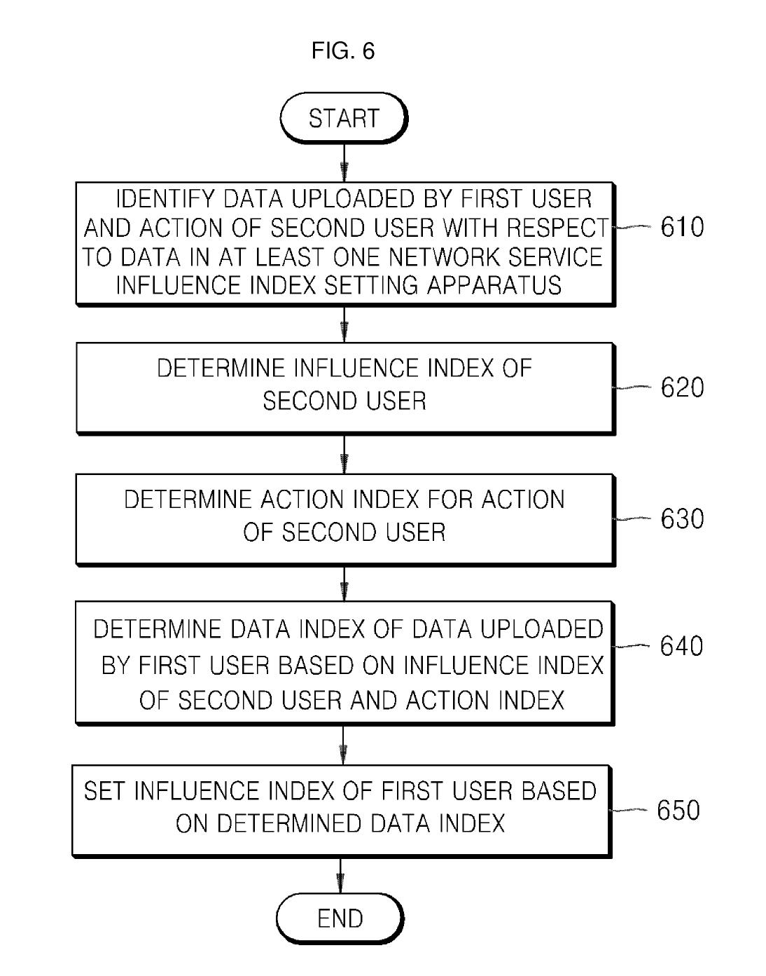

FIG. 6 is a flowchart of a method for setting an influence index of a user in a network service according to another embodiment of the present invention.

Referring to FIG. 6, since step 610 is identical to step 110 of FIG. 1, a redundant description thereof will be omitted.

In step 620, the influence index setting apparatus determines an influence index of a second user. A method for calculating the influence index of the second user is identical to the method of FIG. 1. That is, the influence index setting apparatus extracts a stored previous influence index of the second user, determines a data index of data uploaded by the second user until a predetermined time point, and determines the influence index of the second user based on the previous influence index of the second user and the data index of the data uploaded by the second user. An influence index of the second user at a current time point is determined. In a case where the influence index is calculated according to a period or section, the influence index of the second user in a previous period or section is extracted and determined.

Since step 630 is identical to step 120 of FIG. 1, a redundant description thereof will be omitted.

In step 640, the influence index setting apparatus determines the data index of the data uploaded by the first user based on the influence index and the action index of the second user. As compared to step 130 of FIG. 1, in step 640, the data index is determined by further adding the influence index to the action index. The influence index setting apparatus calculates the data index (value) based on the extracted influence index and the action index of the second user by using a predetermined formula. Mathematical Formula 10 below is an example of a formula for calculating the data index.

Mathematical Formula 10

$$DV ( N ) = {\sum }_{x = a}^{…} {f}_{DV} ( SV ( x ) , SA ( x ) )$$

Referring to Mathematical Formula 10, DV( ) in DV(N) represents the data index, and N represents the data that the first user has created. In addition, SV(x) represents an influence index of x in a time point or period prior to the time point or period at which the data index is calculated as described above. x represents a set of users who have conducted response actions with respect to N data. It can be seen from Mathematical Formula 10 that the data index is calculated based on the influence index and the action index. Mathematical Formula 11 below is an example of f_{DV}(SV(x),SA(x)).

f_{DV}(SV(x),SA(x))=a×SV(x)+b×SA(x) Mathematical Formula 11

Referring to Mathematical Formula 11, a and b are weights. The weights can be set by a provider of the data index setting method.

Table 6 shows an example in which the data index of the data 1 uploaded by the user B is calculated using Mathematical Formulas 10 and 11. According to Mathematical Formula 10, DV₁(B₁)=f_{DV}(SV₀(A),SA₁(A,2))+f_{DV}(SV₀(C),SA₁(C,1))+f_{DV}(SV₀(D),SA₁(D,2)). In the above example, it is assumed that the weights a and b and the influence indexes SV₀(A), SV₀(C), and SV₀(D) of the second user in the previous time point or period are 1. Referring to Mathematical Formula 4, since f_{DV}(SA₁(A,2))=(1−K₁×E_{RE1}(A,2))=0.989081465, f_{DV}(SA₁(C,1))=(1−K₁×E_{RE1}(C,1))=0.697607458, and f_{DV}(SA₁(D,2))=(2−K₁×E_{RE1}(D,2))=0.996557521, DV₁(B₁)=(1+0.98081465)+(1+0.697607458)+(1+0.996557521)=5.683246444. Referring to Mathematical Formula 6, since f_{DV}(SA₁(A,2))=K₁×((M_{RE}(A)+M_{RE}(A)−E_{RE1}(A,2))=1.145490285, f_{DV}(SA₁(C,1))=K₁×E_{RE1}(C,1)=0.302392542, and f_{DV}(SA₁(D,2))=K₁×((M_{RE}(D)+M_{RE}(D)−E_{RE1}(D,2))=1.266804397, DV₁(B₁)=(1+1.145490285)+(1+0.302392542)+(1.266804397)=5.714387224.

Since step 650 is identical to step 140 of FIG. 1, a redundant description thereof will be omitted.

In FIG. 1 or 6, when the influence index of the user is determined, the method for setting the influence index of the user may further include preferentially displaying data uploaded by a user having a high set influence index among a plurality of users.

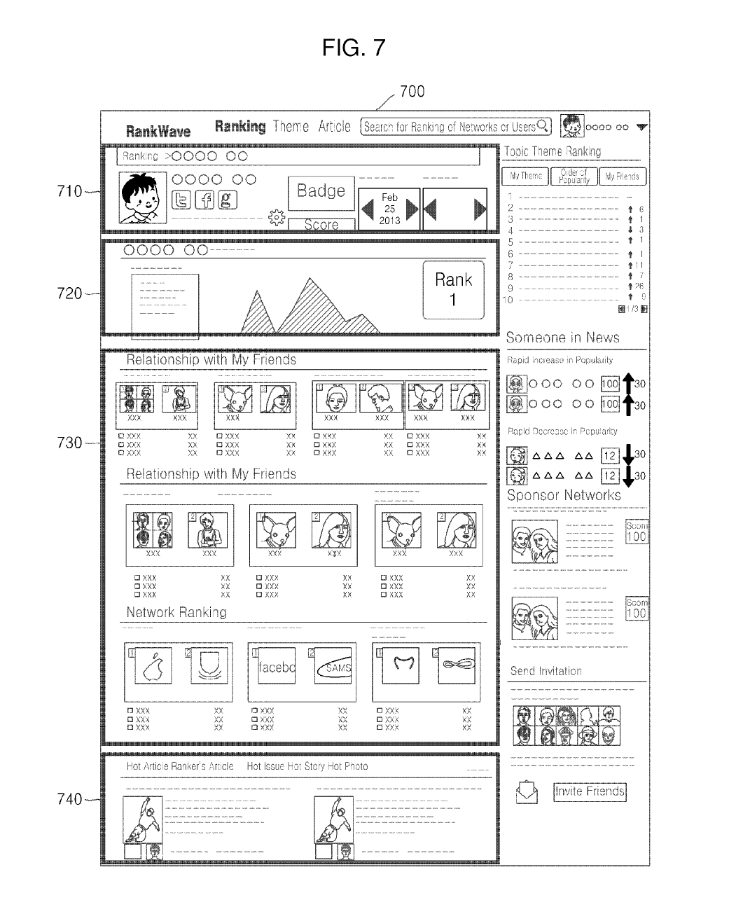

FIG. 7 is a diagram illustrating an example of an interface associated with an influence index according to an embodiment of the present invention. Referring to FIG. 7, information 710 about the user, information 720 about the influence index of the user, information 730 about the influence index of the user according to the category, and information 740 about data uploaded by the user having a high influence index are displayed on an interface 700.

The preset values used for calculating the action index, the weights, the determined action index, the determined data index, and the determined influence index are stored in a predetermined location of the influence index setting apparatus.

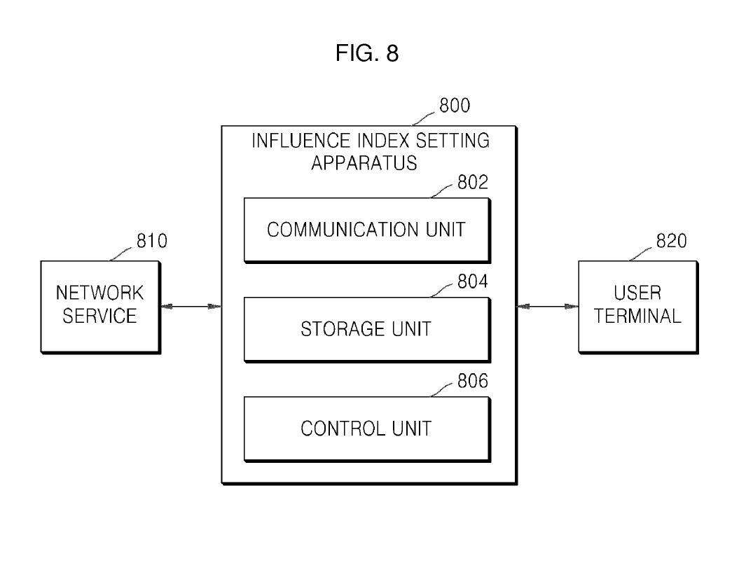

FIG. 8 is a block diagram of an apparatus for setting an influence index of a user in a network service according to an embodiment of the present invention.

Referring to FIG. 8, an influence index setting apparatus 800 includes a communication unit 802, a storage unit 804, and a control unit 806. The influence index setting apparatus 800 can communicate with a network service 810 and a user terminal 820 through a wired/wireless network.

The network service 810 is at least one network service 810 which the user has joined. For example, the network service 810 may be a social network service. The communication unit 802 receives, from the network service 810 which the first user has joined or has been enrolled in, information about an action of a second user with respect to data uploaded by the first user. The user means a user who has joined or has been enrolled in at least one network service 810 and uses the network service. The data means all objects that are exchanged between the users in the network service 810. For example, the data may be information, news, images, videos, URL, position information, and the like. The above-described data is merely exemplary and is not limited thereto. The action of the user means an action of a user that is conducts in the network service 810. Examples of the action of the user include an action of posting a message in a network service such as Facebook, an action of posting a comment or clicking “LIKE”, an action of uploading data such as images or videos, an action of sharing the uploaded data, an action of tweeting in a network service such as Twitter, and an action of retweeting a tweet of other person. The above-described actions of the user are merely exemplary and are not limited thereto. The action of the first user means the first user's uploading data in the network service. In the examples of the actions of the user, posting a message, data upload, and tweeting may be regarded as the action of the first user. The action of the second user means a response action with respect to the action of the first user. That is, the action of the second user means a response action with respect to the data uploaded by the first user. In the example of the actions of the user, posting a comment, clicking “LIKE”, sharing the uploaded data, and retweeting may be regarded as the action of the second user.

The influence index setting apparatus 800 grasps the action of the user, that is, behavior of the user, in at least one network service 810 and the action of other user with respect to the action of the user by using an access token in the at least one network service 810 which the user has joined. The influence index setting apparatus 800 may use the access token to access resources of the network service 810 which the user has joined. The access token is used to request an API of the network service 810 instead of the corresponding user. It is possible to acquire a variety of information about the user in a data index setting network service 810. The Facebook will be taken as an example of the network service 810. In the case of the Facebook, OAuth-based Open API is provided. The key point of the OAuth authentication is to allow a user ID and a password to be input in a page of the Facebook and issue an access token when the ID and the password are matched. In addition, the issued access token may be collected whenever the user wants. If the OAuth method is not used, in the case of creating a linked page logging in to the Facebook, a user's Facebook ID and password are received in a network service 810 to be linked and it is checked whether the ID and the password are matched by using a server-to-server interface provided in the Facebook. However, such a method has a security problem because the user's password can be known in the network service 810 to be linked. Accordingly, the confidence of the service to be linked has to be based and a method of collecting issued authentication information after authentication is unclear. In order to solve these problems, the user's ID and password are input in a service page provided in the Facebook, and an encrypted token is issued so as to make Open API available. In addition to the information indicating that the user has been authenticated, information about the accessible API is included in the access token. In some cases, it is possible to make the corresponding token unavailable by setting the token to be invalid. If the user directly inputs the ID and the password in the page provided in the Facebook and has the access token issued through authentication, the access to the following information is enabled. Examples of the information accessible in the Facebook include “accounts” information that is page information held by the accounts, “activities” information that is profile information about activities, “adaccounts” information that is advertisement management account information, “albums” information that is information about albums, “apprequests” information that is application request information, “books” information that is profile information about books, “checkins” information that is local-based check-in information, “cover” information that is photo information used in a cover, “events” information that is information about events, “family” information that is information about families, “feed” information that is information about activities I have conducted to friends and information about messages I have posted, “friendlists” information that is list information, “friendrequests” information that is friend request information, “friends” information that is information about all friends, “games” information that is profile information about games, “groups” information that is information about groups within the Facebook, “home” information that is information about postings generated in my network, “inbox” information that is information about a folder for holding incoming messages, “interests” information that is information about a matter of interest, “likes” information that is information about favorite things, pages, applications, profiles, “links” information that is information about shared links, “movies” information that is profile information about movies, “music” information that is profile information about music, “mutualfriends” information that is information about mutual friends, “notes” information that is note information, “notifications” information that is information about notifications, “outbox” information that is information about a folder for holding outgoing messages, “payments” information that is information about payments, “permissions” information that is information to which access is permitted by a current access token, “photos” information that is information about tagged photos, “picture” information that is profile photo information, “posts” information that is information about messages I have posted, “scores” information that is information about scores recorded in game applications or the like, “statuses” information that is information about messages I have posted on a wall, “tagged” information that is tagged information, “television” information that is information about TV-related profile, “updates” information that is information about updates, and “video” information that is video-related profile information. The influence index setting apparatus 800 can identify the action of the first user and the action of the second user based on all or part of the information accessible by using the access token. The influence index setting apparatus 800 can receive information through periodic or non-periodic access to the network service via the communication unit 802, identify the actions of the users based on the received information, and acquire an influence index and a data index to be described below.

The control unit 806 determines an action index for the action of the second user. The action index means a value that is set to a response action with respect to an action of a certain user. The action index is calculated using Mathematical Formula 1 above. According to the embodiment of the present invention, the action index can be obtained based on values preset according to the aspects of the response actions. In this regard, the action index is calculated using Mathematical Formula 2 above. The action index is the sum of the values preset according to the aspects of the response actions. The use of the sum in the action index is merely exemplary and the calculation formula may be different according to circumstances. According to another embodiment of the present invention, the action index can be calculated by adding weights to the values preset according to the aspects of the response actions. In this regard, the action index is calculated using Mathematical Formula 3 above. According to another embodiment of the present invention, the action index can be calculated by adding a probability related to occurrence of action to the values preset according to the aspects of the response actions. In this regard, the action index is calculated using Mathematical Formula 4 above. In this case, similar to Mathematical Formula 3, weights can be further added according to the aspects of the actions. According to another embodiment of the present invention, the action index can be calculated using the highest probability among probabilities related to occurrence of action with respect to the values preset according to the aspects of the response actions. In this regard, the action index is calculated using Mathematical Formula 6 above. According to another aspect of the present invention, in a case where there is no access token for a user who intends to calculate the action index, information cannot be acquired from the network service 810 and the action index cannot be calculated. In this case, the control unit 806 calculates the probability of users having the access token as the action index. In the embodiment of the present invention, after the information about the action is extracted, the probability is calculated using a normal distribution. This is merely exemplary and there is no limitation to the probability calculating method. When the action of the user is conducted predetermined times or more, a probability distribution of the corresponding action to be conducted forms a normal distribution. A probability density function may be assumed as a Gaussian function. Thereafter, in the case of calculating an average value and a standard deviation or a variance value, it is possible to estimate a probability of a certain action.

Since the example of determining the action index by using the probability based on Tables 1 to 6 has been described above, a detailed description thereof will be omitted.

The control unit 806 determines a data index of uploaded data based on the action index. The control unit 806 calculates a data index (value) by substituting the action index into a predetermined formula. Mathematical Formula 7 above is an example of a formula for calculating the data index.

The control unit 806 sets the influence index of the first user based on the determined data index. The control unit 806 calculates the influence index based on the data index of the data that the user has created during a predetermined time point or period. The influence index is calculated using Mathematical Formula 8 above. In addition, according to another embodiment of the present invention, the control unit 806 may calculate the influence index by adding the influence index, which is calculated at a time point or period immediately before the time when the current influence index of the first user is calculated, to the data index of the data created by the user during a predetermined time point or period. Mathematical Formula 9 is another formula for calculating the influence index.

According to another aspect of the present invention, the control unit 806 determines an influence index of a second user. A method for calculating the influence index of the second user is identical to the method for calculating the influence index of the first user. That is, the control unit 806 extracts a stored previous influence index of the second user, determines a data index of data uploaded by the second user until a predetermined time point, and determines the influence index of the second user based on the previous influence index of the second user and the data index of the data uploaded by the second user. The control unit 806 determines the influence index of the second user at a current time point. In a case where the influence index is calculated according to a period or section, the control unit 806 extracts and determines the influence index of the second user in the previous period or section.

Thereafter, the control unit 806 determines the data index of the uploaded data based on the influence index and the action index of the second user. The control unit 806 calculates the data index (value) based on the extracted influence index and the action index of the second user by using a predetermined formula. Mathematical Formulas 10 and 11 are examples of formulas for calculating the data index. Then, the control unit 806 determines the influence index of the first user based on the determined data index.

The storage unit 804 stores the preset values used for calculating the action index, the weights, the determined action index, the determined data index, and the determined influence index.

When the influence index of the user is determined, the control unit 806 transmits, to the user terminal 820 via the communication unit 802, a command for preferentially displaying data uploaded by a user having a high set influence index among a plurality of users.

According to the present invention, by setting the data index for the response action of other user with respect to the uploaded data and setting the influence index of the user according to the data index, it is possible to accurately determine data in which the user may be increasingly interested. In addition, by preferentially providing users with data of a user having a high influence index rank, the user can be provided with data in which al users are interested, without being exposed to data meaningless thereto.

The method for setting the user influence index as described above may also be embodied as computer-readable codes on a computer-readable recording medium. The computer-readable recording medium may be any recording medium that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium may also be distributed over network-coupled computer systems so that the computer-readable code is stored and executed in a distributed fashion. Also, functional programs, codes, and code segments for accomplishing the method for setting the user influence index may be easily construed by programmers skilled in the art to which the invention pertains.

The preferred embodiments of the present invention have been described. It can be understood that various modifications and changes can be made without departing from the scope of the present invention by those skilled in the art to which the invention pertains. Accordingly, the disclosed embodiments are to be considered as illustrative and not restrictive. Therefore, the scope of the present invention is defined not by the detailed description but by the claims, and all variations within the scope of the claims and their equivalents are to be construed as being included in the disclosure.

What is claims is:

1. A method for setting an influence index of a user in a server that sets the influence index of the user in a network service, the method comprising:
identifying, by the server, data uploaded by a first user and a response action of a second user with respect to the uploaded data in at least one network service in which the first user has been enrolled;
extracting, by the server, a value preset to the response action of the second user;
determining, by the server, an action index for the response action of the second user by adding a probability related to occurrence of the response action of the second user to the extracted preset value;
determining, by the server, a data index of the uploaded data by substituting the action index into a predetermined formula; and
setting, by the server, the influence index of the first user by substituting the determined data index into a predetermined formula.

2. The method of claim 1, wherein the setting of the influence index of the first user comprises:
extracting, by the server, a prestored previous influence index of the first user; and
setting, by the server, the influence index of the first user by substituting the previous influence index of the first user and the determined data index into a predetermined formula.

3. The method of claim 1, wherein the determining of the action index for the response action of the second user comprises determining, by the server, the influence index of the second user and the action index for the response action of the second user, and
the determining of the data index of the uploaded data by substituting the action index into the predetermined formula comprises determining, by the server, the data index of the uploaded data by substituting the influence index and the action index of the second user into the predetermined formula.

4. The method of claim 3, wherein the determining of the influence index of the second user comprises:
extracting, by the server, a prestored previous influence index of the second user;
determining, by the server, a data index of data uploaded by the second user until a predetermined time point; and
determining, by the server, an influence index of the second user by substituting the previous influence index of the second user and the data index of the data uploaded by the second user into a predetermined formula.

5. The method of claim 1, wherein the determining of the action index for the action of the second user comprises:
extracting, by the server, a value preset to the action of the second user;
adding, by the server, a preset weight to the preset value; and
determining, by the server, the action index for the action of the second user by substituting the preset value and the preset weight into a predetermined formula.

6. The method of claim 1, further comprising preferentially displaying data uploaded by a user according to a set influence index among a plurality of users.

7. An apparatus for setting an influence index of a user in a network service, the apparatus comprising:
a communication unit configured to receive information about a response action of a second user with respect to data uploaded by a first user from at least one network service in which the first user has been enrolled;
a storage unit configured to store a value preset to the response action of the second user; and
a control unit configured to extract the value preset to the response action of the second user, which is stored in the storage unit, determine an action index by adding a probability related to occurrence of the response action of the second user to the extracted preset value, determine a data index of the uploaded data by substituting the action index into a predetermined formula, and set an influence index of the first user by substituting the determined data index into a predetermined formula.

8. The apparatus of claim 7, wherein the storage unit stores a previous influence index of the first user, and
the control unit extracts the previous influence index of the first user, which is stored in the storage unit, and sets the influence index of the first user by substituting the previous influence index of the first user and the determined data index into a predetermined formula.

9. The apparatus of claim 7, wherein the control unit determines an influence index of the second user and an action index for the response action of the second user, and determines a data index of the uploaded data by substituting the influence index of the second user and the action index.

10. The apparatus of claim 9, wherein the storage unit stores a previous influence index of the second user, and
the control unit extracts the previous influence index of the second user, which is stored in the storage unit, determines a data index of data uploaded by the second user until a predetermined time point, and determining an influence index of the second user by substituting the previous influence index of the second user and the data index of the data uploaded by the second user into a predetermined formula.

11. The apparatus of claim 7, wherein the storage unit stores a value preset to the response action of the second user, and
the control unit extracts the value preset to the response action of the second user, which is stored in the storage unit, adds a preset weight to the extracted preset value, and determines an action index for the action of the second user by substituting the preset value and the preset weight into a predetermined formula.

12. The apparatus of claim 7, wherein the control unit transmits, to an external device via the communication unit, a command for preferentially displaying data uploaded by a user according to a set influence index among a plurality of users.
